(19) United States
(12) Patent Application Publication
(10) Pub. No.: US 2023/0412583 A1
(43) Pub. Date: Dec. 21, 2023

(54) Encrypted Communication Platform and Related Systems and Methods

(71) Applicant: Cyber Intell Solution, LLC, Gambrills, MD (US)

(72) Inventor: Alexander Purta, Gambrills, MD (US)

(73) Assignee: Cyber Intell Solution, LLC, Gambrills, MD (US)

(21) Appl. No.: 17/843,199

(22) Filed: Jun. 17, 2022

(51) Int. Cl. H04L 9/40; H04L 61/5007; H04L 61/4511

(52) U.S. Cl. CPC H04L 63/0823; H04L 61/5007; H04L 61/4511; H04L 63/0272; H04L 63/0442

(57) ABSTRACT

Embodiments relate to computer systems and a computer implemented method designed to support and enable a multi-level authentication protocol within a communication platform. The system incorporates a virtual private server (VPS) configured to generate a virtual private network (VPN) certificate without domain name server (DNS) resolution. The VPN certificate is hard coded within a target server, and supports an encrypted communication channel as a first authentication level. A communication platform is provided or supported within the target server, and is further configured to support intra-platform asymmetric encrypted communication at a second authentication level. Accordingly, one or more client machines are selectively directed through the encrypted communication channel to the communication platform where communicate between or among client machines is support via asymmetric encryption techniques.

### BACKGROUND

The present embodiments relate to an encrypted communication platform. More specifically, the embodiments relate to encryption protocols and leveraging the protocols with respect to data and network connections.

An internet protocol (IP) address is a unique address that identifies a device on a public or local network. Every packet of data traversing an IP network contains a source IP address, to indicate an originating or source location, and a destination IP address, to indicate a target location. A virtual private network (VPN) is a private network configured within a public network, e.g. a less secure network, effectively creating a private tunnel through the public network. The VPN provides a server between a client machine with a source location and corresponding source IP address and a destination location with the corresponding destination IP address, so that the destination location only sees the IP address of the VPN and not the source location IP address. Accordingly, VPNs can be used to hide the IP address, geographical location, web activity, or devices being used.

Cyberwarfare is recognized in the art as a computer or network based conflict involving attempts or attacks to disrupt activity. Examples of cyberwarfare include, but are not limited to, viruses, denial of service attacks, hacking and theft of data, and ransomware. Data at rest and data in transit are both susceptible to intercept and manipulation. Cybersecurity, also referred to herein as information technology (IT) security, refers to a body of technologies, processes, and practices designed to protect networks, devices, programs, and data from unauthorized attacks associated with cyberwarfare. It is recognized that the volume and sophistication of cyberattacks are growing and evolving over time. Accordingly, IT security needs to expand and adapt to the evolving nature of cyberattacks to mitigate, if not prevent, the effects of such cyberattacks.

### SUMMARY

The embodiments include a system, computer program product, and methods for creating and supporting an encrypted communication platform. This Summary is provided to introduce a selection of representative concepts in a simplified form that are further described below in the Detail Description. This Summary is not intended to identify key features or essential features of the claimed subject matter, nor is it intended to be used in any way that would limit the scope of the claimed subject matter.

In an aspect, a computer system is provided with a first server configured with a virtual private server (VPS) and an internet protocol (IP) table utility. The VPS is configured to support a cryptographic algorithm, and the IP table utility is configured to configure one or more IP packet filter rules. The VPS is further configured to generate a virtual private network (VPN) certificate without domain name server (DNS) resolution, with the VPN certificate configured to establish an encrypted communication channel. The IP table utility is configured to establish one or more IP packet filter rules to restrict traffic to a destination IP address via a restricted DNS resolution. In addition, the system is provided with a director configured to assess the IP packet filter rules in response to receipt of a communication, which includes the director configured to selectively direct corresponding communication traffic through the encrypted communication channel while obfuscating the destination IP address.

In another aspect, a computer implemented method is provided to support and enable encrypted communication. A first server is configured with a first virtual private server (VPS), with the VPS configured with a cryptographic algorithm. The VPS is configured to generate a VPN certificate, which includes initiating, by the VPS, a virtual private network connection (VPN) certificate without DNS resolution. The VPN certificate is configured to establish an encrypted communication tunnel. One or more IP table rules of the first server are subject to configuration. More specifically, the rules configuration restricts traffic to a destination IP address via a restricted DNS resolution. In response to receipt of a communication from a secondary device, the first server IP table rules are subject to an assessment, and corresponding communication traffic is selectively directed through the communication tunnel while obfuscating the destination IP address.

In yet another aspect, a computer system is provided with a first server configured with one or more tools to support a multi-level authentication protocol, including a first authentication level and a second authentication level. The first authentication level leverages the one or more tools to install a received virtual private network (VPN) certificate, with the installation of the VPN certificate including the one or more tools to create an encrypted communication tunnel, and convert an original internet protocol (IP) address of the first server to a non-routable address. In addition, the one or more tools are leveraged to configure one or more IP table rules of the first server. The configured rules function to restrict received communication traffic from a select IP address. A communication platform is provided within the first server, with the platform configured to facilitate intra-platform asymmetric encryption communication.

In a further aspect, a computer implemented method is provided to support and enable encrypted communication. A computer system is configured to support a multi-level authentication protocol, including a first authentication level and a second authentication level. The first authentication level includes configuring a first server as a virtual private network client, including installing a received virtual private network (VPN) certificate. Installation of the VPN certificate includes creating an encrypted communication tunnel, and converting an original internet protocol address of the first server to a non-routable address. In addition, one or more IP table rules of the first server are subject to configuration to restrict received communication traffic from a select IP address. A communication platform is created or provided on the first server. The platform configured to facilitate intra-platform asymmetric encryption communication.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings referenced herein form a part of the specification, and are incorporated herein by reference. Features shown in the drawings are meant as illustrative of only some embodiments, and not of all embodiments, unless otherwise explicitly indicated.

FIG. 1 illustrates a schematic diagram of a computer to support and enable data encryption and routing of data through the use of one or more VPNs.

FIG. 2 illustrates a schematic diagram of a computer system to illustrate the second server and associated tools to support encrypted communication.

FIG. 3A illustrates a block diagram of a communication platform of the second server.

FIG. 3B illustrate a block diagram of the private communication venue of the second server with an expansion of entities with granted permissions.

FIG. 3C illustrates a block diagram of the communication platform of the second server with two intra-platform communication venues.

FIG. 4 illustrates a flow chart of a process for establishing an encrypted communication channel associated with the first server.

FIG. 5 illustrates a flow chart of a process for establishing a communication platform configured to facilitate and support intra-platform communication encryption.

FIG. 6 illustrates a schematic diagram to depict two or more client machines operatively coupled to the second server via the first server.

FIG. 7 illustrates a block diagram depicting an example of a computer system/server of a cloud based support system, to implement the system and processes described above with respect to FIGS. 1-6.

FIG. 8 illustrates a block diagram depicting a cloud computer environment.

FIG. 9 illustrates a block diagram depicting a set of functional abstraction model layers provided by the cloud computing environment.

### DETAILED DESCRIPTION OF THE EXEMPLARY EMBODIMENTS AND EXEMPLARY METHODS

It will be readily understood that the components of the present embodiments, as generally described and illustrated in the Figures herein, may be arranged and designed in a wide variety of different configurations. Thus, the following detailed description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “one embodiment,” “an exemplary embodiment”, or “an embodiment” means that a particular feature, structure, or characteristic described in connection with the embodiment is included in at least one embodiment. Thus, appearances of the phrases “a select embodiment,” “one embodiment,” “an exemplary embodiment,” or “an embodiment” in various places throughout this specification are not necessarily referring to the same embodiment or different embodiments. The various embodiments may be combined with one another in various combinations that would be understood to those skilled in the art having reference to this disclosure.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

Data in transit, which is also referred to herein as data in motion, is data actively moving from one location to another location across a network connection, either a public network, such as the Internet, or a private network. It is understood in the art that protection of data may be desirable for various reasons, including but not limited to, confidentiality and security concerns. Data protection in transit is directed at protection of data between a source location and a target location. Examples of data transit include, but are not limited to, data traveling across networks and data transfer from a local storage device to a remote storage device. Regardless of the form of direction of data transit, effective measures are required to protect such data from any form of security breach or tampering.

The VPN is a tool to protect data in transit by providing privacy and anonymity through creating a private network within a public network. As shown and described herein, the VPN is subject to an encryption protocol, effectively creating an encrypted communication tunnel. The use of the encrypted VPN, together with configuration of internet protocol (IP) table rules, creates a communication environment obfuscating a destination IP address. As shown and described herein, configuration of the encrypted VPN is provided to support concealment of private data.

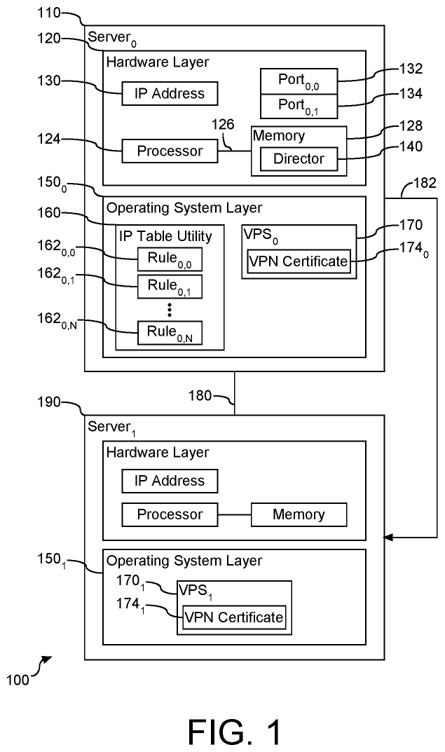

Referring to FIG. 1, a schematic diagram (100) of a computer to support and enable data encryption and routing of data through the use of one or more VPNs is shown. The diagram (100) illustrates a computer server (110), also referred to herein as a first server or server₀, to support and enable data encryption and routing of data through the use of one or more VPNs. In an exemplary embodiment, and as described in detail below, the first server (110) functions to encrypt and obfuscate communications associated with an operatively coupled second server. It is understood in the art that a computer server is a computer or system that provides resources, data, services, or program to other computers, referred to herein as clients or client machines. To function as a server, the server is configured to listen to requests from client machines operatively coupled to the server across a network connection. Upon receiving a request from a client machine, the server may verify the identity of the client machine to ensure that the client machine has permission to access the data or resources requested.

As shown herein, the first server (110) is configured with a hardware layer (120) and an operating system (O/S) layer (150₀). The hardware layer includes a processor, also referred to herein as a processing unit (124), operatively coupled to memory (128) across a bus (126). A tool in the form of a director (140) is shown embedded within the memory (128), with the director (140) configured to selectively direct communication. Details of the functionality of the director (140) are shown and described below. In an exemplary embodiment, the hardware layers are configured with 4 virtual core (Vcore) processing, 16 GB of random access memory (RAM), GB solid state drive (SSD), and 3 terabytes (TB) bandwidth. In an embodiment, each operating system layer is provided with Ubuntu, e.g. an open source operating system on Linux. In an embodiment, the first server (110), as described in detail below, can be custom configured. For example, the custom configuration may entail allocation of hardware resources, such as CPU cores, memory, bandwidth, etc., to support demand.

An internet protocol (IPv4) address is a numeric label, or in an embodiment an alphanumeric label (IPv6), assigned to each computer and other device connected to a computer network that uses internet protocol for communication. This address allows these devices to send and receive data over the internet. Every device that is capable of connecting to the internet has a unique IP address. Transmission control protocol/internet protocol (TCP/IP) is a suite of communication protocols used to connect hosts on the Internet and transmit data. In TCP/IP, a port is an endpoint to a logical connection and the way a client program specifies a specific server program on a computer network. As shown herein, the server has a public IP address, shown herein as IP address ° (130). In addition, the first server (110) is configured with network ports in the form of numbered addresses to direct network traffic, with each port being a numbered address used to facilitate and direct network traffic. Port numbers range from 0 to 65535, with the port number identifying a port type. As shown herein, the first server (110) is configured with two open ports that are externally visible, and all other ports are closed or otherwise unavailable to support and enable network traffic. In an exemplary embodiment, the director (140) configures the ports and their corresponding visibility, e.g. sets select ports to an open position and closes select ports. The open ports of the first server (110) are shown herein as port_{0,0} (132) and port_{0,1} (134). In an exemplary embodiment, the open ports are port 443 and port 1999. Port 443 is a well-known dedicated port for all secured hypertext transfer protocol (HTTPS) traffic which masquerades well known VPN ports 400, 4500, 1194, 51820. The art of configuring the VPN connection over port 443, as shown and described herein, is to ensure that the port it is not ever blocked, considering that blocking port 443 would equate blocking the internet connection. Port 1999 is a random port that is utilized to masquerade well know port 22 for a secure shell connection (SSH) in order to obfuscate SSH signature, while having secure access to a VPN server for configurations of a network, or in an exemplary embodiment a proprietary network. In the embodiment shown herein, port_{0,0} (132) and port_{0,1} (134) are ports 443 and 1999, respectively. In an embodiment, different port numbers may be assigned to the open server ports.

The first server (110) is configured with an IP table utility (160) in the user space of the O/S layer (150₀). In an exemplary embodiment, the IP table utility (160) is a user-space utility program that allows a system administrator to configure IP packet filter rules associated with directing network traffic packets. In an exemplary embodiment, when a connection request is received from a client machine, or an alternative external device, the IP tables program searches for an internal rule, e.g. IP table rule, to match to the connection request. As shown and described herein the IP table utility (160) is configured with individual rules, shown herein as rule_{0,0} (162_{0,0}), rule_{0,1} (162_{0,1}), . . . , rule_{0,N} (162_{0,N}). The quantity of rules shown herein is for exemplary purposes and should not be considered limiting. In an exemplary embodiment, one or more of the IP tables rules, e.g. rule_{0,0} (162_{0,0}), rule_{0,1} (162_{0,1}), . . . , rule_{0,N} (162_{0,N}), is configured to restrict traffic to a destination address via a restricted DNS resolution. In an exemplary embodiment, the IP table rules re-directs traffic to a designated IP address and restricts traffic to a specific sub-domain address. IP traffic is defined as the flow of data across a network connection. Since all websites are hosted on servers, and servers on networks have IP addresses to denote their location, anytime a site is access IP traffic is generated. Accordingly, the IP table rules restricting traffic forces the traffic to a specific address.

As shown herein, the first server (110) is provided with a VPN server (170₀). In an exemplary embodiment, the VPN server (170₀) is configured in the O/S layer (150₀). The VPN server (170₀) also referred to herein as a virtual private server (VPS), is a server created using software virtualization. The VPS (170₀), labeled herein as VPS₀, is a virtualized instance created within a server. In an exemplary embodiment, the VPS₀ (170₀) is configured with a cryptographic algorithm. In an embodiment, the cryptographic algorithm incorporates post-quantum cryptography. Although only shown with a single VPS₀ (170₀), in an exemplary embodiment, the first server (110) can host a plurality of VPS's. Similarly, in an exemplary embodiment, the first server (110) allocates system resources, such as CPU, memory, and storage, to each configured VPS.

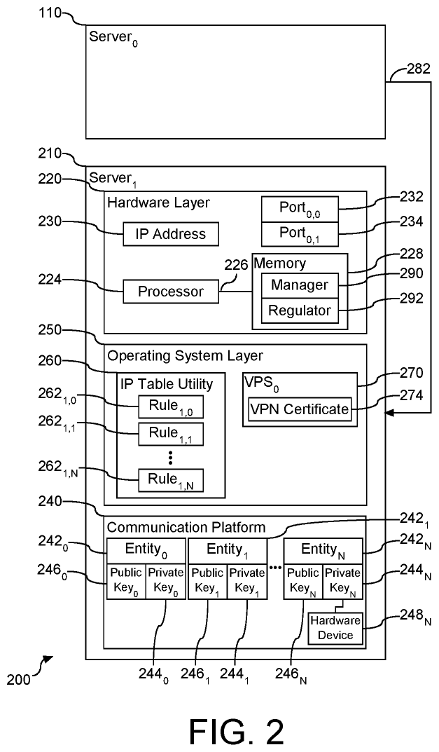

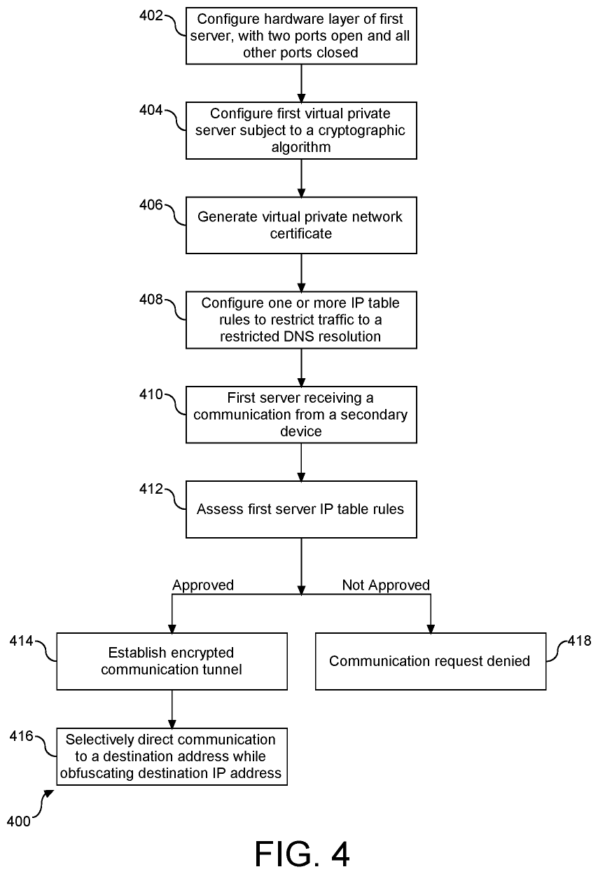

The first server (110), also referred to herein as a primary server, is configured to receive IP traffic from one or more secondary devices (not shown) via one of the open ports, port_{0,0} (132) and port_{0,1} (134). Following receipt of a communication from a secondary device (not shown), the director (140) assesses the IP table rules with respect to access permissions. Details of the assessment are shown and described in FIG. 4. The VPS₀ (170₀) is configured to generate a VPN certificate (174₀), which is used to form a secure communication channel between two entities in a network to ensure sent data is encrypted and private. In an embodiment, the two entities are shown herein as the first server (110) and a second server (190), also referred to herein as a secondary server. Details of the second server (190) are shown and described in FIG. 2. As shown, the second server (190) is operatively connected to the first server (110) across a communication channel (180). As a response to access permissions being granted, the first server (110), and more specifically VPS₀ (170₀), creates or otherwise generates the VPN certificate (174₀). In an exemplary embodiment, the VPN certificate (174₀) is subject to configuration, and once configured it is communicated or otherwise transmitted across the communication channel (180) to the second server (190) for installation. In an embodiment, the configuration of the VPN certificate (174₀) includes removal of a DNS resolver.

Domain name server (DNS) resolution is referred to herein as a process of translating IP addresses to domain names. In an exemplary embodiment, the VPN certificate (174₀) is configured so that it has no DNS resolution. The VPN certificate (174₀) is subject to installation on the second server (190). Once imported into the second server, servers (190), the certificate (174₁) is enabled and configured to be connected. With the importation and established connection of the certificate (174₀, a communication tunnel (182), also referred to herein as an encrypted communication channel, is generated to the first server (110). The installed and activated VPN certificate is shown herein as VPN certificate (174₁). Similar to the first server (110), a second VPS, shown herein as VPS₁ (170₁) is configured within the O/S layer (150₁), and the received VPN certificate (174₁) is positioned within VPS₁ (170₁) to complete the establishment of the encrypted communication channel (182) configured to support and enable secured communications between the first and second servers, (110) and (190), respectively. In an embodiment, once the VPN certificate (174₀) is imported to the second server (190) from the first server (110), the certificate (174₁) is configured and enabled to an ON position to support a secure connection between the first and second servers (110) and (190), respectively. The configuration of the VPN certificate (174₁) is local to the second server (190). In an example, in the case that the second server (190) is subject to a reboot, the VPN certificate (174₁) will self-initiate as part of the reboot and re-establish the connection (180), and in an embodiment the communication tunnel (182), with the first server (110). In an exemplary embodiment, the communication tunnel (182) is encrypted with a post quantum resistant (PQR) algorithm protocol. Details of the generation and encryption of the communication tunnel (182) are shown and described in FIG. 4. With the installation of the VPN certificate (174₁) on the second server (190) and formation of the encrypted communication tunnel (182), the second server (190) assumes a non-routable, i.e. private, IP address. Non-routable IP addresses are commonly used inside a local area or private network, and one of their characteristics is that their packets cannot be directed through a routable IP address.

The encrypted communication tunnel (182), also referred to herein as an encrypted tunnel, functions to direct a secondary device (not shown) and corresponding communication and associated communication traffic to the second server (190) while obfuscating the destination IP address, also referred to as the destination address, of the second server (190). The installation, e.g. hard coding, of the VPN certificate (174₁) on the second server (190) creates the encrypted tunnel (182), which in an exemplary embodiment is a uni-directional tunnel configured to accommodate communication from the first server (110) to the second server (190). As noted above, the configured IP table utility (160), and more specifically the rules therein, function to restrict traffic to a destination address. The permission(s) granted by one or more of the IP table rules e.g. rule_{0,0} (162_{0,0}), rule_{0,1} (162_{0,1}), . . . , rule_{0,N} (162_{0,N}), directs the corresponding communication to the second server (190) via the encrypted tunnel (182). Accordingly, the IP table rules together with the VPS and the generation and installation of the VPN certificate, creates an encrypted and non-routable, e.g., private, communication channel (182) between the first and second servers (110) and (190), respectively.

As shown and described in FIG. 1, the first server (110) is configured to establish an encrypted communication tunnel (182) to the secondary server (190). Referring to FIG. 2, a schematic diagram (200) is provided to illustrate the second server of a computer system and associated tools to support encrypted communication. The diagram (200) illustrates the second computer server (210), also referred to herein as the second server or server₁, to support and enable a private or encrypted communication platform accessible via one or more VPNs. As shown herein, the second server (210) is configured with a hardware layer (220) and an operating system (O/S) layer (250). The hardware layer includes a processor (224), also referred to herein as a processing unit, operatively coupled to memory (228) across a bus (226). As shown herein, the memory (228) includes tools in the form of a manager (290) and a regulator (292) configured to support multi-level authentication. In an exemplary embodiment, the hardware layers are configured with 4 virtual core (Vcore) processing, 16 GB of random access memory (RAM), 80 GB solid state drive (SSD), and 3 terabytes (TB) bandwidth. In an embodiment, each operating system layer is provided with Ubuntu, e.g. an open source operating system on Linux.

The second server (210) has a public IP address, shown herein as IP address₁ (230). In addition, the second server (210) is configured with network ports in the form of numbered addresses to direct network traffic, with each port being a numbered address used to facilitate and direct network traffic. Port numbers range from 0 to 65535, with the port number identifying a port type. As shown herein, the second server (210) is configured with two open ports that are externally visible, and all other ports are closed or otherwise unavailable to support and enable network traffic. The open ports of the second server (210) are shown herein as port_{1,0} (232) and port_{1,1} (234). In an exemplary embodiment, the open ports are port 443 and port 1999. Port 443 is a well-known dedicated port for all secured hypertext transfer protocol (HTTPS) traffic which masquerades well known VPN ports 400, 4500, 1194, 51820. In the embodiment shown herein, port_{1,0} (232) and port_{1,1} (234) are ports 443 and 1999, respectively. In an embodiment, different port numbers may be assigned to the open server ports.

The second server (210) is configured to support a multi-level authentication protocol. The first level authentication protocol is directed at installation of the VPN certificate (174₀) received from the first server, server₀, (110). The received or installed VPN certificate is referred to herein as VPN certificate (274). As shown herein, the received VPN certificate (274) is installed within VPS₁ (270) in the O/S layer (250). In an embodiment, the manager (290) manages installation of the VPN certificate (274). In an exemplary embodiment, the VPN certificate (274) is generated by the first server (110) and transmitted to the second server (210) across a communication channel. The installation of the VPN certificate (274) on the second server (210) includes the manager (290) to create an encrypted communication tunnel (282) between the second server (210) and the originator of the VPN certificate, e.g. the first server (110). In an exemplary embodiment, the communication tunnel (282) is a uni-directional tunnel configured to enable the second server (210) to receive communication and packets but not to communicate or otherwise transmit communications and packets from the second server (210) to another device. In an embodiment, the manager (292) is configured to encrypt the communication tunnel (282) with a cryptographic algorithm. In an exemplary embodiment, the cryptographic algorithm incorporates post-quantum cryptography in the form the PQR encryption.

Similar to the configuration of the first server (110), the second server (210) is also configured with an IP table utility (260). In an exemplary embodiment, the IP table utility (260) is a user-space utility program that allows a system administrator to configure IP packet filter rules associated with directing network traffic packets. The IP table utility (260) is employed to configure one or more corresponding rules to restrict communication traffic. The traffic restriction limits receipt of communications and corresponding packets from a select IP address, i.e. the IP address of the first server (110). In an exemplary embodiment, the IP address of the first server (110) is obfuscated when the VPN certificate (274) is activated and the encryption tunnel (282) between the first and second servers (110) and (210), respectively, is established. The original IP address, e.g. IP address₁ (230), of the second server (210) is converted to or designated as a non-routable IP address, e.g. a private IP address. In an exemplary embodiment, the uniform resource locator (URL) of the second server (210) resolves to the IP address of the first server (110), with traffic selectively re-directed to the second server (210), also referred to herein as a target server, in a manner that is transparent. Accordingly, installation of the VPN certificate (274) is managed by the director (290) to support and enable creation of the communication tunnel (282) and conversion of the IP address to a non-routable address.

In an exemplary embodiment, the IP table utility (230) is configured to only accept traffic, e.g. communication across the communication tunnel (282), e.g. VPN tunnel, from the first server (110) on a particular protocol and port. When a request is received from another machine, or an alternative external device, the IP table utility (260), or in an embodiment an IP tables program, searches for an internal rule, e.g. IP table rule, to match to the connection request. As shown and described herein the IP table utility (230) is configured with individual rules, shown herein as rule_{1,0} (262_{1,0}), rule_{1,1} (262_{1,1}), . . . , rule_{1,N} (262_{1,N}). The quantity of rules shown herein is for exemplary purposes and should not be considered limiting. In an exemplary embodiment, the manager (290) configures one or more of the IP table rules, e.g. rule_{1,0} (262_{1,0}), rule_{1,1} (262_{1,1}), . . . , rule_{1,N} (262_{1,N}), to restrict traffic to communication(s) received from a select IP address, e.g. IP address₀ (130), of the first server (110). Accordingly, the IP table rules restricting traffic only permits communications to be received from a specific address, e.g. the address of the first server (110), effectively functioning as a first authentication level or authentication protocol.

As shown and described herein, the second sever (210) creates or otherwise provides a communication platform (240), with the platform (240) configured to support and facilitate intra-platform communication between two or more entities. In an embodiment, access to the platform (240) is controlled via access to the tunnel (282). In an exemplary embodiment, the intra-platform communication platform (240) employs or supports a second encryption level managed by the regulator (292). In an embodiment, the second encryption level is asymmetric encryption, also referred to herein as asymmetric cryptography, which is a cryptographic system that uses mathematically related pair of keys, also referred to herein individually as key pairs, for encryption and decryption. Each key pair consists of a public key and a corresponding private key. In an embodiment, the generation of the public-private key pairs depends on cryptographic algorithms. Effective security requires keeping the private key private, while the corresponding public key can be distributed without compromising security. For example, to send an encrypted communication or packet between two entities, a first entity in receipt or possession of a public key of a second entity uses the received public key to encrypt the message. The second entity in receipt of the encrypted message decrypts the encrypted message using their private key that is related to their public key that was used by the first entity as a first layer of the asymmetric encryption with the corresponding private key being the second layer of the asymmetric encryption. In another example, if the first entity encrypts the message or packet using their private key, the message can be decrypted by the second entity only using the public key of the first entity, thereby authenticating the first entity. These encryption and decryption processes of the asymmetric cryptography happen automatically, or in an embodiment, as a background process.

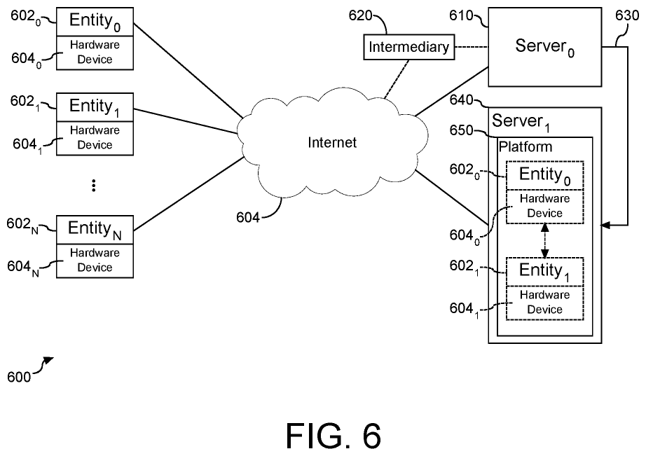

Various computing devices may selectively access or be admitted to the communication platform (240). As shown and described in FIG. 6, the computing devices, also referred to herein individually as an entity or a client machines, are operatively coupled to one or both of the first and second servers via a network connection. Once admitted, the platform (240) provides a venue for inter-entity communication with asymmetric encryption. One of more of the entities admitted to the communication platform (240) may have an operatively coupled physical hardware device. By way of example, the admitted devices are shown herein as entity₀ (242₀), entity₁ (242₁, . . . , entity_{N} (242_{N}), with entity_{N} (242_{N}) shown with operatively coupled hardware device (248_{N}). In an embodiment, one or more additional hardware devices (not shown) may be provided operatively coupled to one or more of the entities. For example, in an embodiment, an entity may have two or more operatively coupled hardware devices, with each of the hardware devices being separately addressable. One or more of the platform admitted computing devices may dynamically generate a control signal to a physical hardware device, a process controlled by software, or a combination of the physical hardware device and the software. In an exemplary embodiment, the control signal selectively controls the operatively coupled physical hardware device (248_{N}), or in an embodiment a process controlled by software or a combination of the physical hardware device and the software, with the control signal configured to selectively modify a physical functional aspect of the device (248_{N}). In an embodiment, the device (248_{N}) may be a first physical device operatively coupled to an internal component, or in an embodiment a second physical device, and the issued first signal may modify an operating state or physical state of the internal component or the second device. For example, the first device (248_{N}) may be a product dispenser, and the control signal may modify or control a product dispensing rate to accommodate the rate at which the second device receives the dispensed product. In an embodiment, the regulator (292) computes a control action and constructs or configures the control signal that aligns or is commensurate with the computed control action. In an exemplary embodiment, the control action may be applied as a feedback signal to directly control an event injection to maximize a likelihood of realizing an event or operating state of the device (248_{N}).

The communication platform (240) is accessed or accessible to entities via the communication tunnel (282). In an exemplary embodiment, multiple entities may receive access to the communication platform (240) via the first authentication level IP table rules, e.g. rule 1, 0 (262_{1,0}), rule_{1,1} (262_{1,1}), . . . , rule_{1,N} (262_{1,N}), and corresponding traffic restriction permitting access to two or more specific addresses, thereby creating or enabling access to platform (240) to multiple overlapping entities. For example, the communication platform (240) is shown with multiple entities having received access via the first authentication level, shown herein as entity₀ (242₀), entity₁ (242₁), . . . , entity_{N} (242_{N}). Each entity shown in the platform (240) has assigned private-public key pairs. As shown herein, entity₀ (242₀) is shown with private key₀ (244₀) and a corresponding public key₀ (246₀), entity₁ (242₁) is shown with private key₁ (244₁) and a corresponding public key₁ (246₀, . . . and entity_{N} (240_{N}) is shown with private key_{N} (244_{N}) and a corresponding public key_{N} (246_{N}). In an embodiment, the entities shown herein, e.g. entity₀ (242₀), entity₁ (242₁), . . . , entity_{N} (240_{N}), may also be in the form of individual client machines.

As shown and described above, each entity present on the platform (240) accesses the platform via the first authentication level, e.g. encrypted communication tunnel (282) and corresponding IP table rules (264_{1,0}), rule_{1,1} (262_{1,1}), . . . , rule_{1,N} (262_{1,N}). Once admitted to the platform (240) via one or more of the IP table rules, e.g. rule_{1,0} (262_{1,0}), rule_{1,1} (262_{1,1}), . . . , rule_{1,N} (262_{1,N}), two or more of the entities may establish a private or direct communication channel within the platform (240). In an embodiment, the private or direct communication channel is managed by the regulator (292), with the channel referred to herein as an intra-platform communication channel. In an exemplary embodiment, the regulator (292) supports exchange of public keys within the platform (240) and formation of a corresponding private communication channel, and also supports removal or closure of the channels. Details of the formation of removal of the private communication channel(s) is shown and described below.

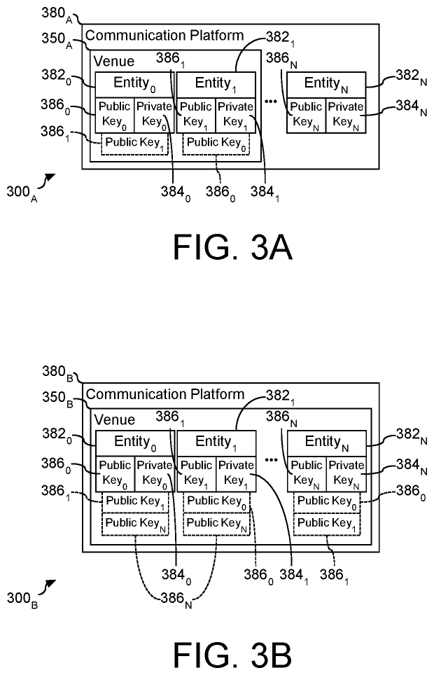

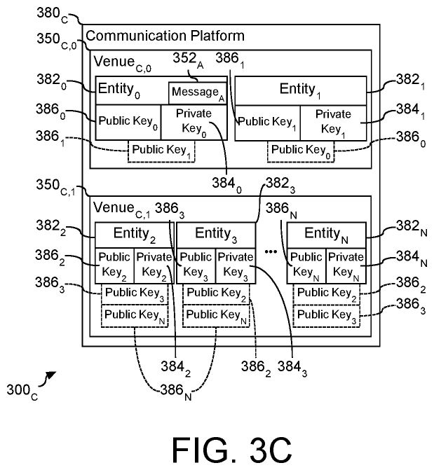

Referring to FIG. 3A, a block diagram (300_{A}) is provided to illustrate the communication platform of the second server. As shown herein, the communication platform_{A} (380_{A}) is shown with a plurality of entities, shown herein as entity₀ (382₀), entity₁ (382₀, . . . , entity_{N} (382_{N}), with each entity individually admitted to the communication platform_{A} (380_{A}) via one of more IP table rules. The quantity of entities shown herein is for exemplary purposes and should not be considered limiting. In an exemplary embodiment, platform membership may be transitory with entities entering and exiting the platform at various times. Similar to the description provided in FIG. 2, each entity granted access to the communication platform_{A} (380_{A}) has a pair of public and private keys. As shown herein, entity₀ (382₀) is shown with private key₀ (384₀) and a corresponding public key₀ (386₀), entity₁ (382₁) is shown with private key₁ (384₁) and a corresponding public key₁ (386₀, . . . and entity_{N} (382_{N}) is shown with private key_{N} (384_{N}) and a corresponding public key_{N} (386_{N}). A private intra-platform communication venue (350_{A}) is shown formed between entity₀ (382₀) and entity₁ (382₁) within the platform (380_{A}). The formation of the private communication venue (350_{A}) takes place by an exchange of public keys between the entities that are members of the venue (350_{A}), e.g. entity₀ (382₀) and entity₁ (382₀. As shown by way of example, the public key exchange shows entity₀ (382₀) in receipt of public key₁ (386₁) and shows entity₁ (382₁) in receipt of public key₀ (386₀). Accordingly, the entity membership to the private communication venue (350_{A}) with the communication platform_{A} (380_{A}) is managed by exchange of entity public keys.

Once formed or established, the private communication venue (350_{A}) supports direct, and in an embodiment bi-directional, encrypted communication between the entities, e.g. entity₀ (382₀) and entity₁ (382₀, that formed the venue (350_{A}). In the example shown in FIG. 3A, only two entities have permission to access the venue (350_{A}), e.g. entity₀ (382₀) and entity₁ (382₀. In an embodiment, the venue (350_{A}) may accept one or more additional entities as members. Referring to FIG. 3B, a block diagram (300_{B}) is provided to illustrate the private communication venue of the second server with an expansion of entities with granted permissions. As shown in FIG. 3A, a private communication venue (350_{A}) was formed within communication platform B (380_{A}) with membership to the venue (350_{A}) shown with two entities. In the example shown herein in FIG. 3B, a private communication venue (350_{B}) is shown within communication platform B (380_{B}) with the venue (350_{B}) being an expansion of venue (350_{A}) to include at least three entity members. As shown, the entity_{N} (382_{N}) is granted access to the venue (350_{B}) by a public key exchange with the other entities in the venue (350_{B}) with entity membership to the venue (350_{B}) shown as entity₀ (382₀), entity₁ (382₀, and entity_{N} (382_{N}). Acceptance of the membership for each of the entities takes place by exchange of the public key with other entity members of the venue (350_{B}) As shown by way of example, the public key exchange shows entity₀ (382₀) in receipt of public key₁ (386₁) and public key_{N} (386_{N}), entity₁ (382₁) in receipt of public key₀ (386₀) and public key_{N} (386_{N}), and entity_{N} (382_{N}) in receipt of public key₀ (386₀) and public key₁ (386₀. Accordingly, membership to the venue (350_{B}) shown herein is expanded from membership of venue (350_{A}) with the inclusion of at least three entity members.

The communication venue (350_{A}) within communication platform_{A} (380_{A}) and communication venue (350_{B}) within communication platform B (380_{B}) of the second server as shown in FIGS. 3A and 3B, respectively, is demonstrated with entity membership to support and enable intra-platform encrypted communication. In an embodiment, multiple communication venues may be formed within the communication platform. Referring to FIG. 3C, a block diagram (300_{C}) is provided to illustrate the communication platform of the second server with two intra-platform communication venues. As shown, communication platform_{C} (380_{C}) is shown with two communication venues, shown herein as venue_{C,0} (350_{C,0}) and venue_{C,1} (350_{C,1}). Two venues are shown herein for exemplary purposes. In an embodiment, the communication platform (380_{C}) may be limited to a single communication venue, as shown in FIGS. 3A and 3B, or may be expanded to include more than two communication venue.

As shown herein by way of example, venue_{C,0} (350_{C,0}) is referred to as a first intra-platform venue formed with members shown as entity₀ (382₀) and entity₁ (382₁) via exchange of their corresponding public keys, e.g. public key₀ (386₀) and public key₁ (386₀, and a second intra-platform venue is shown as venue_{C,1} (350_{C,1}) is formed with three members shown herein as entity₂ (382₂), entity₃ (382₃), and entity_{N} (382_{N}) via exchange of their corresponding public keys, e.g. public key₂ (386₂), public key₃ (386₃), and public key_{N} (386_{N}). Once formed or established, the private communication venues (350_{C,0}) and (350_{C,1}) individually support direct encrypted communication between or among entity members. By way of example, venue_{C,0} (350_{C,0}) permits and enables intra-platform communication between entity₀ (382₀) and entity₁ (382₀, and venue_{C,1} (350_{C,1}) permits and enables intra-platform communication between or among any of entity₂ (382₂), entity₃ (382₃), and entity_{N} (382_{N}). An entity member of a venue may communicate directly with other entity members of the venue via a second level of encryption. Examples of supported communications within the individual venue, include voice, video, and text based communications. For example, entity₀ (382₀) may encrypt a text based communication, e.g. message_{A} (352_{A}), using their private key₀ (384₀). Message_{A} (352_{A}) can be decrypted by an entity that is a member of the formed venue using the sending entity's public key, e.g. public key₀ (386₀), thus authenticating the sending entity. In an exemplary embodiment, the encryption and decryption of the supported communication may take place as a background process, e.g. transparent to the channel members, without requiring the channel members to physically lock and unlock the communication. As entities that have passed the first authentication level join the communication platform (380), they may join an existing intra-platform communication venue, shown herein as venue_{A} (350_{A}), venue_{B} (350_{B}), venue_{C,0} (350_{C,0}), and venue_{C,1} (350_{C,1}) or they may form one or more additional channels.

Each of the venues, venue_{C,0} (350_{C,0}) and venue_{C,1} (350_{C,1}), may be individually and selectively expanded to receive additional entity members, or in an embodiment, contracted to reduced membership. In an exemplary embodiment, an individual entity may be a member of two or more venues. As shown and described above, venue expansion takes place via exchange of entity public keys. Venue contraction takes place via removal of the public key with the entity that was a recipient of one or more public keys. Once contracted, the venue may be subject to expansion via an exchange or re-exchange of entity public keys. One or more new intra-platform venues may be established via an inter-entity exchange of public keys. In an embodiment, venue membership may selective and/or dynamic. Accordingly, membership in one or more of the platform venues is established via exchange of entity public keys, and is dis-established via one or more member entities removing a received public key.

Referring to FIG. 4, a flow chart (400) is provided to illustrate a process for establishing an encrypted communication channel associated with the first server. As shown in FIG. 1, the first server is configured with a hardware layer and communication ports. The hardware layer ports are set with only two of the ports open, while all other ports are closed (402). The configuration of the ports facilitates establishing the communication tunnel, as described below. As shown, the first server is configured with or subject to configuration with a first virtual private server (VPS), with the VPS configured or subject to configuration with a cryptographic algorithm (404). In an exemplary embodiment, the configuration of the VPS employs a cryptographic algorithm incorporating post-quantum cryptography. The VPS is configured to generate a virtual private network (VPN) certificate in an effort to establish an encrypted communication tunnel, also referred to herein as an encrypted communication channel, also referred to herein as an encrypted communication tunnel, (406). In an exemplary embodiment, at step (406) the VPS initiates a VPN connection certificate without DNS resolution. In an embodiment, the established communication tunnel is based on PQR encryption. In addition to the VPN certificate generation, one or more IP table rules of the first server are configured or subject to configuration, with the rules directed at restricting traffic, e.g. communications and packets, to a destination address via a restricted DNS resolution (408). The restricted DNS resolution forces all traffic through a specific address, thereby re-directing the traffic to a designated IP address. In an exemplary embodiment, the traffic restricting at step (408) directs traffic to a specific sub-domain address. In an embodiment, the restricted DNS resolution at step (408) forces communication traffic through a designated address, e.g. the sub-domain address. As one or more communications are received by the first server from a secondary device (410), the IP table rules of the first server are assessed (412), the encrypted communication tunnel is established (414), and the received communication is selectively directed through the communication tunnel to a destination address while the destination IP address is obfuscated (416). As further shown, if the IP table rules assessment does not approve the communication transmission to the destination address, the communication request is denied (418). Accordingly, the first server is responsible for establishing an encrypted communication tunnel, and together with the configuration of IP tables rules, the first server selectively directs traffic through the established tunnel.

The establishment of the encrypted communication tunnel at step (406) requires a recipient device, shown and described herein as the second server, and includes installation of the VPN certificate on the second server operatively coupled to the first server. The installation of the VPN certificate on the second server creates the encrypted communication uni-directional tunnel as an encrypted communication channel, and the configuration of the IP table rules at step (408) directs communication traffic from the first server to the operatively coupled second server via the encrypted communication tunnel. Accordingly, the configuration of the ports and IP tables together with the first VPS and issuance of a corresponding VPN certificate all contribute to establishing the encrypted communication tunnel associated with the first server.

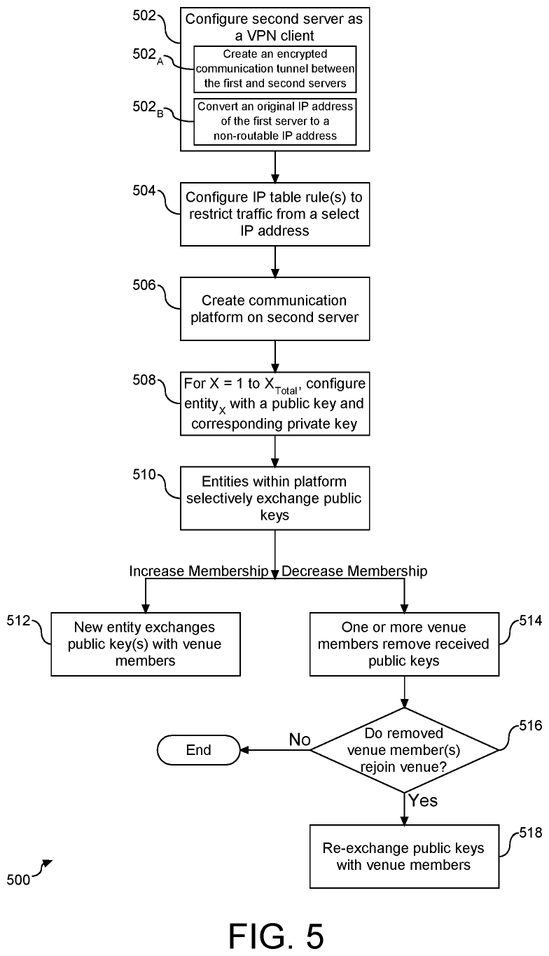

Referring to FIG. 5, a flow chart (500) is provided to illustrate a process for establishing a communication platform configured to facilitate and support intra-platform communication encryption. A multi-level authentication protocol is configured, with at least a first authentication level and a second authentication level. The first authentication level includes configuring the second server as a VPN client (502), which includes receipt and installation of the VPN certificate from the first server. In an exemplary embodiment, installation of the VPN certificate includes hard-coding the VPN certificate on the second server. The VPN installation at step (502) creates the encrypted communication tunnel between the first and second servers (502_{A}) and converts an original IP address of the first server to a non-routable IP address (502_{B}). The communication tunnel created at step (502) is an encrypted channel between the first and second server, and in an exemplary embodiment, the communication tunnel is established via PQR protocol. Following step (502), one or more IP table rules of the second server are subject to configuration to restrict receipt of communication traffic from a select IP address, e.g. the IP address of the first server, (504). In an exemplary embodiment, the second server assumes a non-routable IP status when the VPN certificate is activated. Once the encrypted communication tunnel between the first and second servers is established, a communication platform is created on the second server (506), with the communication platform configured to facilitate intra-platform asymmetric encryption communication between or among entities, e.g. client machines. The asymmetric encryption communication supported in the communication platform at step (506) is referred to herein as a second authentication level of the multi-level authentication protocol.

The communication platform supported on the second server, as shown as step (506), is configured to support intra-platform communication between or among multiple entities. Each of these entities is configured with asymmetric encryption protocols. As shown herein, the counting variable X individually refers to the entities, also referred to as client machines, and the variable X_{Total} refers to the initial set of entities configured to be permitted and supported within the second server communication platform. Each entity x is configured with a public key and a corresponding private key (508). To support the first and second authentication levels, and more specifically to support and enable intra-platform communication, each entity x must be granted individual access to the encrypted communication tunnel. After two or more of the entities have accessed the communication platform via the encrypted tunnel, at least two of the entities that want to communicate within the platform exchange their respective public keys (510). By way of example, a first entity receives a second public key from a second entity within the platform, and a second entity receives a first public key from the first entity within the platform. The public key exchange at step (510) establishes a private communication venue for the first and second entities. The private communication channel, also referred to herein as a platform venue, supports direct encrypted communication between the first and second entities within the platform. In an exemplary embodiment, the platform venue supports and enables intra-platform direct communication(s) with entities within the venue, with the included communication formats being voice, video, and text based communications.

Each entity with access to the communication platform established within the second server needs to pass the first authentication level established or supported by the first server. In an embodiment, the second server may have one venue within the platform or multiple venues within the platform. In an embodiment, each venue within the platform may have different membership compositions, as shown in FIGS. 3A, 3B, and 3C. Venue membership is selective and subject to change. Membership may be increased via a third entity, e.g. a new entity, accessing the second server platform via the first authentication level, and exchanging public keys with the first and second entities with prior membership in the venue (512). Similarly, venue membership may be decreased by one or more of the member entities removing one or more received public keys (514). In an embodiment, a formed venue within the platform may be closed or otherwise removed by each entity member removing their received public keys. Once removed from a venue, the previously removed entity may re-join the venue (516) by re-exchanging public keys with the venue members (518). Similarly, a previously formed venue that has been closed or removed may be re-established by re-exchanging public keys with entities within the platform. Accordingly, the establishment or closing of venues within the platform is based upon exchange or removal of corresponding entity public keys, respectively.

Referring to FIG. 6, a schematic diagram (600) is provided to illustrate two or more client machines, also individually referred to herein as an entity, operatively coupled to the second server via the first server. As shown herein, the client machines, entity₀ (602₀), entity₁ (602₁), . . . and entity_{N} (602_{N}) are operatively coupled to the first server, server₀ (610) across a network connection. Each of the client machines is shown herein with an operatively coupled hardware device. For example, entity₀ (602₀) is shown with hardware device (604₀), entity₁ (602₁) is shown with hardware device (604₀, . . . , and entity_{N} (602_{N}) is shown with hardware device (604_{N}). In an embodiment, only a selection of the entities has an operatively coupled hardware device. Similarly, in an embodiment, one or more of the entities may have two or more operatively coupled hardware devices, with each of the devices having a separate IP address and being separately addressable. Each of the client machines is shown operatively coupled to a global communication network, e.g. the Internet, (604). By way of example, entity₀ (602₀) is shown with an operatively connection to the Internet via communication channel (604₀), entity₁ (602₁) is shown with an operatively connection to the Internet via communication channel (604₁), and entity_{N} (602_{N}) is shown with an operatively connection to the Internet via communication channel (604_{N}). In an embodiment, communications from one or more of the client machines across their individual network channels, e.g. (604₀), (604₁), . . . (604_{N}), are directed to the first server (610) via an intermediary (620), also referred to as an intermediary server. The purpose and function of the intermediary (620) is to enhance security. In an embodiment, communications from any of the client machines to the destination server (640) are directed to the intermediary server (620), and a sub-domain created on the intermediary server (620) directs the communication(s) to the IP address of the destination server (640).

As shown in FIGS. 1-5, two levels of authentication are provided in the system to support privacy. A first level of the authentication is established between the first and second servers (610) and (640), respectively. One established, a communication tunnel (630), also referred to herein as a communication channel, is formed between the first and second servers (610) and (640), respectively. In an exemplary embodiment, the communication tunnel (630) is encrypted. Details of the creation of the communication tunnel are shown and described in FIG. 1. As shown and described in FIGS. 1 and 2, the communication tunnel (630) is uni-directional and functions to directed encrypted communications from the first server to the operatively coupled second server. Accordingly, the communication tunnel (630) is a first of two levels of security to ensure encrypted communication between or among entities.

Once the communication tunnel (630) is formed, the second level of security may be utilized to support inter-entity communication. As shown in FIGS. 3A-3C, the second server, server₁ (640) hosts a platform (650) to support and enable communication among member entities. As shown in FIGS. 4 and 5, access to the platform (650) is limited to approved entities. Once approved and access to the platform (650) has been attained, one or more venues may be established within the communication platform (650) of the second server, server₁, (640) to support and enable encrypted and direct communication between select entities, e.g. inter-entity communication within the communication platform (650), e.g. intra-platform communication. By way of example, entity₀ (602₀) and entity₁ (602₁) are shown with a direct communication channel (660) within the communication platform (650) of the second server (640). Details of the asymmetric encryption protocols employed within the platform (650) to support and enable the communication channel (660) are shown and described in FIGS. 3A-3C. Each of the first and second entities (602₀) and (602₁), respectively, is shown herein with access to the second server (640) via a first level of encryption of the communication tunnel (630). In an embodiment, each of the first and second entities (602₀) and (602₁), respectively, is separately authenticated by the first server (610) to attain access to the communication platform (650). As shown and described above, inter-entity communication within the platform (650) requires the entities therein to exchange their respective public keys. Accordingly, the inter-entity asymmetric encryption protocol within the platform is a second of the two levels of security to ensure and support inter-entity and intra-platform encrypted communication.

By way of example, inter-entity communication within the platform (650) supports dynamic configuration of a control signal for issuance to an operatively coupled hardware device. For example, entity₀ (602₀) may dynamically configure and/or issue a control signal to selectively control or modify functionality of hardware device (604₁). The control signal is communicated from entity₀ (602₀) to entity₁ (602₁) using asymmetric encryption. In an exemplary embodiment, the hardware device (604₁) includes a corresponding address (not shown) to identify the device. The control signal, or in an embodiment a feedback signal, is subject to the asymmetric encryption and configured to selectively control or modify an event injection to the operatively coupled hardware device. In an exemplary embodiment, the control signal selectively controls a physical state of the operatively coupled hardware device. Accordingly, the multi-level encryption enables and supports inter-entity communication in combination with controlling an operating state of a physical hardware device.

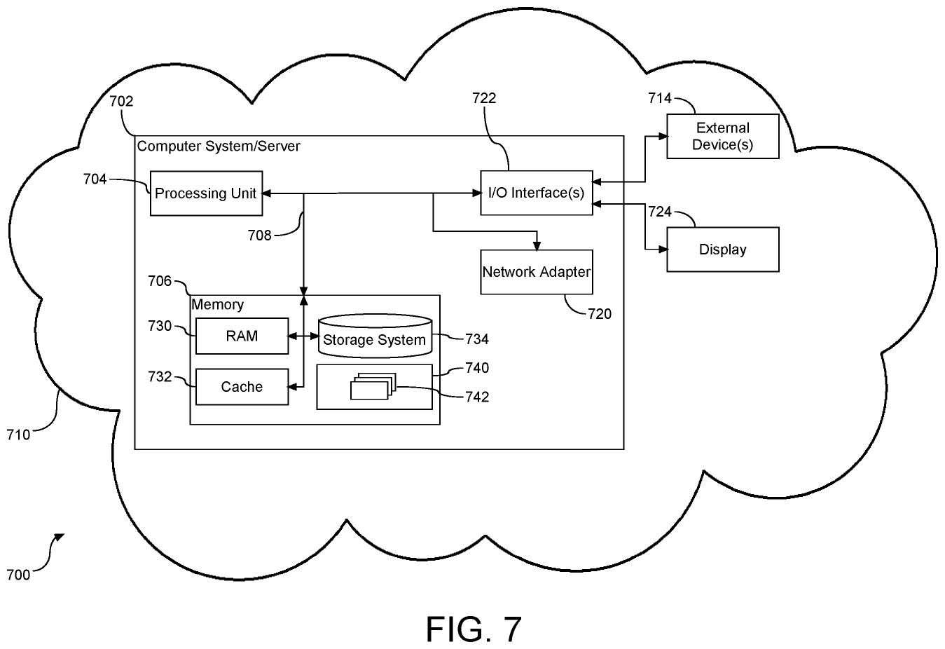

In an exemplary embodiment, aspects of the form and function of the communication platform and the venue(s) configured and supported therein may be embodied in a computer system with a plurality of distributed servers, e.g. the first server and the second server. For example, the servers may be distributed across a cloud-based system. With reference to FIG. 7, a block diagram (700) is provided illustrating an example of a computer system/server (702), hereinafter referred to as a host (702) in communication with a cloud-based support system, to implement the systems and processes described above with respect to FIGS. 1-6. Host (702) is operational with numerous other general purpose or special purpose computing system environments or configurations. Examples of well-known computing systems, environments, and/or configurations that may be suitable for use with host (702) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and file systems (e.g., distributed storage environments and distributed cloud computing environments) that include any of the above systems, devices, and their equivalents.

The host (702) may be described in the general context of computer system-executable instructions, such as program modules, being executed by a computer system. Generally, program modules may include routines, programs, objects, components, logic, data structures, and so on that perform particular tasks or implement particular abstract data types. The host (702) may be practiced in distributed cloud computing environments (710) where tasks are performed by remote processing devices that are linked through a communications network. In a distributed cloud computing environment, program modules may be located in both local and remote computer system storage media including memory storage devices.

As shown in FIG. 7, host (702) is shown in the form of a general-purpose computing device, with the hardware and operating system layers and configuration as shown in FIG. 1. The components of host (702) may include, but are not limited to, one or more processors or processing units (704), e.g. hardware processors, a system memory (706), and a bus (708) that couples various system components including system memory (706) to processing unit (704). Bus (708) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Host (702) typically includes a variety of computer system readable media. Such media may be any available media that is accessible by host (702) and it includes both volatile and non-volatile media, removable and non-removable media.

Memory (706) can include computer system readable media in the form of volatile memory, such as random access memory (RAM) (730) and/or cache memory (732). By way of example only, storage system (734) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (708) by one or more data media interfaces.

Program/utility (740), having a set (at least one) of program modules (742), may be stored in memory (706) by way of example, and not limitation, as well as one or more application programs, other program modules, and program data. Each of the one or more application programs, other program modules, and program data or some combination thereof, may include an implementation of a networking environment. Program modules (742) generally carry out the functions and/or methodologies of embodiments to assess and manage provisioning of one or more encrypted communication tunnels in a distributed resource environment. For example, the set of program modules (742) may include tools to support and the first and second levels of encryption to provide secure and private inter-entity encrypted communication.

Host (702) may also communicate with one or more external devices (714), such as a keyboard, a pointing device, etc.; a display (724); one or more devices that enable a user to interact with host (702); and/or any devices (e.g., network card, modem, etc.) that enable host (702) to communicate with one or more other computing devices. Such communication can occur via Input/Output (I/O) interface(s) (722). Still yet, host (702) can communicate with one or more networks such as a local area network (LAN), a general wide area network (WAN), and/or a public network (e.g., the Internet) via network adapter (720). As depicted, network adapter (720) communicates with the other components of host (702) via bus (708). In one embodiment, a plurality of servers, e.g. nodes, is in communication with the host (702) via the I/O interface (722) or via the network adapter (720). It should be understood that although not shown, other hardware and/or software components could be used in conjunction with host (702). Examples, include, but are not limited to: microcode, device drivers, redundant processing units, external disk drive arrays, RAID systems, tape drives, and data archival storage systems, etc.

In this document, the terms “computer program medium,” “computer usable medium,” and “computer readable medium” are used to generally refer to media such as main memory (706), including RAM (730), cache (732), and storage system (734), such as a removable storage drive and a hard disk installed in a hard disk drive.

Computer programs (also called computer control logic) are stored in memory (706). Computer programs may also be received via a communication interface, such as network adapter (720). Such computer programs, when run, enable the computer system to perform the features of the present embodiments as discussed herein. In particular, the computer programs, when run, enable the processing unit (704) to perform the features of the computer system. Accordingly, such computer programs represent controllers of the computer system.

In one embodiment, host (702) is a node of a cloud computing environment. The host (702) is configured to communicate with other servers in the environment, and to create a dual obfuscated network to interface with a client machine in support of a request. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher layer of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some layer of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

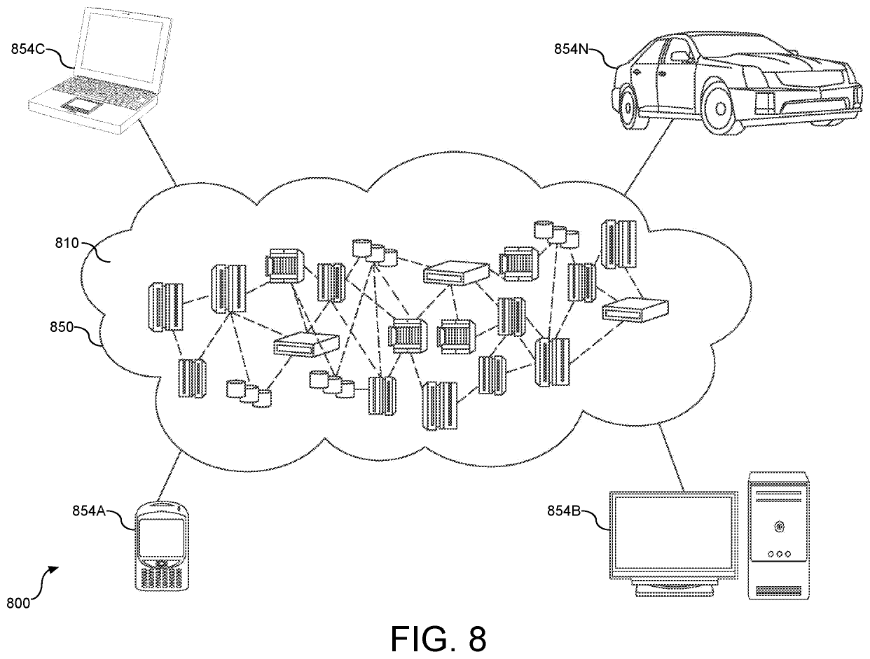

Referring now to FIG. 8, an illustrative cloud computing network (800). As shown, cloud computing network (800) includes a cloud computing environment (850) having one or more cloud computing nodes (810) with which local computing devices used by cloud consumers may communicate. Examples of these local computing devices include, but are not limited to, personal digital assistant (PDA) or cellular telephone (854A), desktop computer (854B), laptop computer (854C), and/or automobile computer system (854N). Individual nodes within nodes (810) may further communicate with one another. They may be grouped (not shown) physically or virtually, in one or more networks, such as Private, Community, Public, or Hybrid clouds as described hereinabove, or a combination thereof. This allows cloud computing environment (800) to offer infrastructure, platforms and/or software as services for which a cloud consumer does not need to maintain resources on a local computing device. It is understood that the types of computing devices (854A-N) shown in FIG. 8 are intended to be illustrative only and that the cloud computing environment (850) can communicate with any type of computerized device over any type of network and/or network addressable connection (e.g., using a web browser).

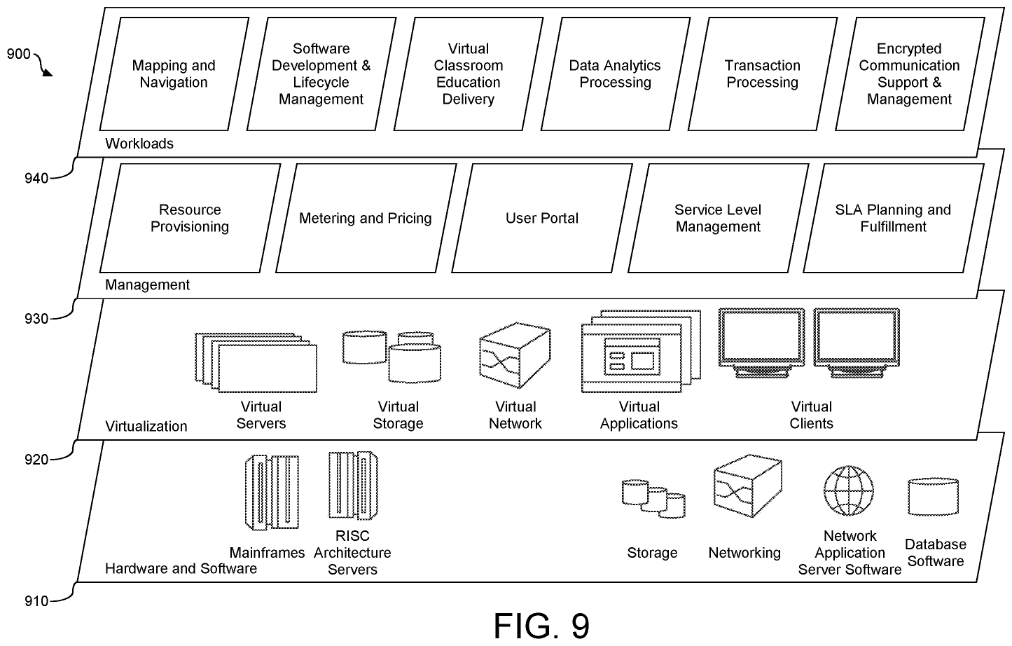

Referring now to FIG. 9, a set of functional abstraction layers (800) provided by the cloud computing network of FIG. 8 is shown. It should be understood in advance that the components, layers, and functions shown in FIG. 9 are intended to be illustrative only, and the embodiments are not limited thereto. As depicted, the following layers and corresponding functions are provided: hardware and software layer (910), virtualization layer (920), management layer (930), and workload layer (940).

The hardware and software layer (910) includes hardware and software components. Examples of hardware components include physical servers, storage devices, networks and networking components. Examples of software components include network application server software.

Virtualization layer (920) provides an abstraction layer from which the following examples of virtual entities may be provided: virtual servers; virtual storage; virtual networks, including virtual private networks; virtual applications and operating systems; and virtual clients.

In one example, management layer (930) may provide the following functions: resource provisioning, metering and pricing, user portal, service layer management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service layer management provides cloud computing resource allocation and management such that required service layers are met. Service Layer Agreement (SLA) planning and fulfillment provides pre-arrangement for, and procurement of, cloud computing resources for which a future requirement is anticipated in accordance with an SLA.

Workloads layer (940) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and encrypted communication support and management.

While particular embodiments of the present embodiments have been shown and described, it will be obvious to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “one or more” or “at least one” and indefinite articles such as “a” or “an”; the same holds true for the use in the claims of definite articles.

The present embodiments may be a system, a method, and/or a computer program product. In addition, selected aspects of the present embodiments may take the form of an entirely hardware embodiment, an entirely software embodiment (including firmware, resident software, micro-code, etc.) or an embodiment combining software and/or hardware aspects that may all generally be referred to herein as a “circuit,” “module” or “system.” Furthermore, aspects of the present embodiments may take the form of computer program product embodied in a computer readable storage medium (or media) having computer readable program instructions thereon for causing a processor to carry out aspects of the present embodiments. Thus embodied, the disclosed system, a method, and/or a computer program product are operative to support the functionality and operation of a dual obfuscated network configuration.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

Aspects of the present embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that, although specific embodiments have been described herein for purposes of illustration, various modifications may be made without departing from the spirit and scope of the embodiments. Accordingly, the scope of protection of the embodiments is limited only by the following claims and their equivalents.

What is claimed is:

1. A computer system comprising:
a first server configured with a virtual private server (VPS) and an internet protocol (IP) table utility, the VPS configured to support a cryptographic algorithm and the IP table utility configured to configure one or more IP packet filter rules;
the VPS configured to generate a virtual private network (VPN) certificate without domain name server (DNS) resolution, the VPN certificate configured to established an encrypted communication channel;
the IP table utility configured to establish one or more IP packet filter rules to restrict traffic to a destination IP address via a restricted DNS resolution;
a director configured to assess the IP packet filter rules in response to receipt of a communication, including the director to selectively direct corresponding communication traffic through the encrypted communication channel while obfuscating the destination IP address.

2. The computer system of claim 1, wherein the cryptographic algorithm incorporates post-quantum cryptography.

3. The computer system of claim 1, wherein configuration of the encrypted communication channel communicatively coupled to the first server includes installation of the VPN certificate on a second server, and wherein the obfuscated destination IP address is a second server address.

4. The computer system of claim 3, wherein the VPN certificate installation creates the communication channel as a uni-directional encrypted tunnel, and wherein the configured one or more IP table rules directs the communication traffic to the operatively coupled second server via the encrypted communication channel.

5. The computer system of claim 3, further comprising the second server to assume a non-routable IP address following installation and activation of the VPN certificate.

6. The computer system of claim 1, wherein the restricted DNS resolution of the destination address is configured to force communication traffic through a designated address.

7. The computer system of claim 1, further comprising the director to manage one or more port settings of the first server, including the director to configure the first server with only two ports open and all other ports closed, wherein one of the open ports establishes the encrypted communication channel.

8. A computer implemented method comprising:
configuring a first server with a first virtual private server (VPS), the VPS configured with a cryptographic algorithm;
the VPS configured to generate a VPN certificate, including initiating, by the VPS, a virtual private network connection (VPN) certificate without DNS resolution, the VPN certificate configured to establish an encrypted communication tunnel;
configuring one or more IP table rules of the first server, the rules configured to restrict traffic to a destination IP address via a restricted DNS resolution; and
in response to receipt of a communication from a secondary device, assessing the first server IP table rules, and selectively directing corresponding communication traffic through the communication tunnel while obfuscating the destination IP address.

9. The computer implemented method of claim 8, wherein the cryptographic algorithm incorporates post-quantum cryptography.

10. The computer implemented method of claim 8, wherein configuring the communication tunnel communicatively coupled to the first server includes installing the VPN certificate on a second server, wherein the obfuscated destination IP address is a second server address.

11. The computer implemented method of claim 10, wherein the VPN certificate installation creates the communication tunnel as a uni-directional encrypted tunnel, and wherein the configured one or more IP table rules directs communication traffic to the operatively coupled second server via the encrypted communication tunnel.

12. The computer implemented method of claim 11, further comprising the second server to assume a non-routable IP address following installation and activation of the VPN certificate.

13. The computer implemented method of claim 8, wherein the restricted DNS resolution of the destination address forces communication traffic through a designated address.

14. The computer implemented method of claim 8, further comprising configuring a hardware layer of the first server with only two ports open and all other ports closed, wherein one of the open ports establishes the communication tunnel.

15. A computer system comprising:
a first sever configured with one or more tools to support a multi-level authentication protocol, including a first authentication level and a second authentication level, first authentication level including the one or more tools to:
install a received virtual private network (VPN) certificate, wherein installation of the VPN certificate includes the one or more tools to:
create an encrypted communication tunnel, and
convert an original internet protocol (IP) address of the first server to a non-routable address; and
configure one or more IP tables rules of the first server, the rules configured to restrict received communication traffic from a select IP address; and
the first server including a communication platform configured to facilitate intra-platform asymmetric encryption communication.

16. The computer system of claim 15, wherein the asymmetric encryption communication is the second authentication level.

17. The computer system of claim 15, wherein access to the communication platform is controlled via access to the encrypted communication tunnel.

18. The computer system of claim 17, further comprising the first client machine configured to dynamically issue a control signal to a physical hardware device operatively coupled to the second client machine, a process controlled by software, or a combination thereon, the control signal configured to selectively control a physical state of the operatively coupled device, the software, or a combination thereof.

19. The computer system of claim 18, wherein the dynamically issued control signal is subject to asymmetric encryption.

20. The computer system of claim 17, further comprising a regulator configured to support exchange of first and second public keys, wherein the exchange establishes a private communication channel between the first and second clients in the accessed platform.

21. The computer system of claim 20, wherein the established private communication channel supports direct encrypted communication between the first client and the second client, the direct encrypted communication including voice, video, or text based communication.

22. The computer system of claim 21, further comprising a removal of the first public key from the second client, wherein the key removal closes the private communication channel.

23. The computer system of claim 22, further comprising the regulator configured to re-establish the private communication channel in the platform following removal of the exchanged public keys, the re-establishment including a re-exchange of the first and second public keys.

24. The computer system of claim 15, further comprising the manager configured to encrypt the communication tunnel with a cryptographic algorithm incorporating post-quantum cryptography.

25. A computer implemented method comprising:
configuring a system with a multi-level authentication protocol, including a first authentication level and a second authentication level, the first authentication level including:
configuring a first server as a virtual private network client, including installing a received virtual private network (VPN) certificate, wherein installation of the VPN certificate includes:
creating an encrypted communication tunnel, and
converting an original internet protocol address of the first server to a non-routable address; and
configuring one or more IP tables rules of the first server, the rules configured to restrict received communication traffic from a select IP address; and
creating a communication platform on the first server, the platform configured to facilitate intra-platform asymmetric encryption communication.

26. The computer implemented method of claim 25, wherein the asymmetric encryption communication is the second authentication level.

27. The computer implemented method of claim 25, further comprising configuring two or more client machines with asymmetric encryption protocols, including a first client machine having a first public key and first private key, and a second client machine having a second public key and second private key.

28. The computer implemented method of claim 27, further comprising granting communication platform access to the first and second clients via the encrypted communication tunnel.

29. The computer implemented method of claim 28, further comprising establishing a private communication channel between the first and second clients in the accessed platform via exchange of the first and second public keys.

30. The computer implemented method of claim 29, wherein the private communication channel supports direct encrypted communication between the first client and the second client, the direct communication including voice, video, or text based communication.

31. The computer implemented method of claim 30 further comprising one of the first client or the second client removing the exchanged public keys, wherein the key removal closes the private communication channel.

32. The computer implemented method of claim 31, further comprising re-establishing the private communication channel in the platform following removal of the exchanged public keys, the re-establishing including re-exchanging the first and second keys.

33. The computer implemented method of claim 27, further comprising the first client machine dynamically issuing a control signal to a physical hardware device operatively coupled to the second client machine, a process controlled by software, or a combination thereon, the control signal configured to selectively control a physical state of the operatively coupled device, the software, or a combination thereof.

34. The computer implemented method of claim 33, wherein the dynamically issued control signal is subject to asymmetric encryption.

35. The computer implemented method of claim 25, further comprising configuring the encrypted communication tunnel with a cryptographic algorithm incorporating post-quantum cryptography.
